(19) United States
(12) Patent Application Publication
(10) Pub. No.: US 2010/0323333 A1
(43) Pub. Date: Dec. 23, 2010

(54) METHOD AND APPARATUS FOR RANDOMLY PROVIDING LEARNING INFORMATION TO USER THROUGH COMMUNICATION TERMINAL

(76) Inventors: Keon-Sang Yoo, Gyeonggi-do (KR); So-Yeon Lee, Gyeonggi-do (KR)

Correspondence Address: IP & T GROUP LLP, 7700 Little River Turnpike, Suite 207, Annandale, VA, 22003, US

(21) Appl. No.: 12/867,342

(22) PCT Filed: Oct. 9, 2008
(86) PCT No.: PCT/KR2008/005936

§ 371 Date: Aug. 12, 2010

(30) Foreign Application Priority Data
Feb. 12, 2008 (KR) 10-2008-0012779
Jul. 19, 2008 (KR) 10-2008-0070372

(51) Int. Cl. G09B 19/00

(52) U.S. Cl. 434/157

(57) ABSTRACT

The present invention relates to a method and apparatus for randomly providing learning information to a user through a communication terminal of the user. The present invention has an effect on an improvement of word power of a foreign language or on learning achievement in chemical or scientific formulas for students by providing the learning information through a portable communication terminal held by the user.

The method according to the present invention includes the steps of: selecting one of random time modes, which are stored in a memory, or one of random time intervals, which are calculated by a calculator, when a function to randomly provide words is selected by a user selecting a word information group to be memorized based on a user's selection randomly outputting words in the selected word information group with a sound or a text through a hand-held communication terminal and selecting another word information group based on a user's selection when the memorizing of the selected word information group has been completed.

### TECHNICAL FIELD

The embodiment described herein relates to a word information display apparatus capable of enabling a user to efficiently memorize words and improve vocabulary ability. More particularly, the embodiment described herein relates to a word information display apparatus capable of improving vocabulary ability of a user by providing the user with words at a random time interval.

### BACKGROUND ART

In general, it is the most important thing to increase vocabulary ability in foreign language learning. To this end, various methods have been suggested and used. The basic desire of all learners is to efficiently increase the vocabulary ability in a short time. One of methods for increasing the vocabulary ability is disclosed in Korean Patent Application No. 2006-0093967, entitled “periodic word information display apparatus and method using a mobile communication terminal”.

According to Korean Patent Application No. 2006-0093967, word information input by a user is stored in a mobile communication terminal, a display period is set based on the Hermann Ebbinghaus forgetting curve or selection of the user, and then the word information is provided to the user according to the display period set by the user.

However, according to the conventional method for providing the words, since the user is familiar with the display period, learning effect may be degraded. Further, according to the learning method based on the Hermann Ebbinghaus forgetting curve, the learning effect can be improved only when a user consciously memorizes words displayed at the display time.

Further, the user must input words into the mobile communication terminal one by one and set a display period for each word, causing inconvenience of the user.

### DISCLOSURE

### Technical Problem

Embodiments of the present invention are directed to providing a word information display apparatus, which operates at a random time interval and enables a user to efficiently memorize words by allowing the user to repeatedly access word information at a random time interval through initial setting of a user.

### Technical Solution

The foregoing and/or other aspects of the present invention are achieved by providing a word information display apparatus operating at a random time interval. The word information display apparatus includes a random time interval calculator configured to calculate the random time interval, a memory unit configured to store word information, which is to be memorized, classified into a plurality of word groups, a controller configured to sequentially or randomly select a word stored in the word groups at the time interval calculated by the random time interval calculator, and a display unit configured to display the selected word under control of the controller.

According to another aspect of the present invention, a word information display apparatus operating at a random time interval is provided. The word information display apparatus includes a memory unit configured to store word information, which is to be memorized, classified into a plurality of word groups, and at least one random time mode, a controller configured to sequentially or randomly select a word stored in the word group according to the random time mode stored in the memory unit, and a display unit configured to display the selected word under control of the controller.

The word group includes the word information classified according to at least one of a level, frequency of use and a category, and a plurality of words are set in each group based on grades of the words.

The random time interval is calculated by performing operation using one of a π value and a time value, and the random time interval calculated through the operation is stored with at least one mode.

According to another aspect of the present invention, a word information display method performed at a random time interval. The word information display method includes selecting one of a random time mode stored in a memory and a random time interval calculated by a random time interval calculator if a word information display function performed at the random time interval is selected by a user, selecting by the user a word information group to be memorized, displaying word information of the selected word information group through a mobile communication terminal in a form of a text or sound, and selecting by the user another word information group when the user has completely memorized the selected word information group.

### ADVANTAGEOUS EFFECTS

Operations and effects of the present invention having the features are as follows.

According to the word information display apparatus operating at the random time interval based on the present invention, a user can maximize learning effect by watching or listening word information repeatedly displayed at the random time interval.

That is, an alarm function is applied to memory technology (electronic dictionary function included in a mobile communication terminal) of a normal terminal. The alarm function is performed at the random time interval. Thus, a user repeatedly accesses words to be memorized at the random time interval, so that the learning effect can be maximized.

Further, according to the present invention, the alarm function is performed at the random time interval instead of a periodic time interval, so that a user is familiar with the display period to prevent the word learning effect from being degraded. Further, words are repeatedly displayed at the random time interval, so that the user can unconsciously memorize the words even if the user does not consciously memorize the words.

Recently, words are grouped according to levels thereof and stored in the normal electronic dictionary provided in a mobile communication terminal. Thus, if a user selects a group of words, the word group are automatically displayed, so that it is not necessary for the user to input word information into the mobile communication terminal one by one.

Further, since the word information display apparatus of the present invention provides one or more random time modes, it is not necessary to set a period for each word.

Furthermore, when the word information display apparatus having the automatic wireless Internet access function of the present invention is applied to the mobile communication terminal, if a user presses a send button of the mobile communication terminal, the user can use the wireless Internet English word service. Thus, the wireless Internet access procedure is simplified, so that the problem, such as limitation of word information provided to the display apparatus caused by the lack of memory capacity, can be solved.

### DESCRIPTION OF DRAWINGS

FIG. 1 is a block diagram showing a configuration of a word information display apparatus operating at a random time interval according to the present invention;

FIG. 2 is a flowchart showing a word information display method performed at a random time interval according to the present invention; and

FIG. 3 is a flowchart showing a procedure of automatically accessing wireless Internet when a word alarm function is performed according to a word information display method performed at a random time interval based on the present invention.

### BEST MODE

Hereinafter, a preferred embodiment of the present invention will be described in detail with reference to the accompanying drawings.

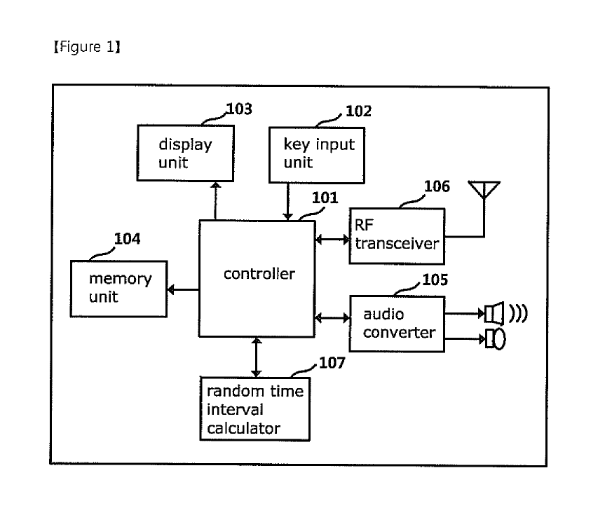

FIG. 1 is a block diagram showing a configuration of a word information display apparatus operating at a random time interval according to the present invention.

The word information display apparatus of the present invention includes a key input unit 102, a display unit 103, a memory unit 104, an audio converter 105, an RE transceiver 106, a random time interval calculator 107 and a controller 101.

The controller 101 controls all elements of the word information display apparatus. The controller 101 receives a key input signal from the key input unit 102 and controls the display unit 103 to display image information corresponding to the key input signal.

Further, if a word information display function performed at the random time interval is selected, one of a random time mode stored in the memory unit 104 and a random time interval calculated by the random time interval calculator 107 is selected, and a word information group to be memorized is selected.

If word information display starts, initial word information is displayed through a speaker, a vibrator and the display unit 103. Then, if display time of next word information is reached according to the random time interval selected by a user, the word information of the selected group is displayed in a sequential sequence or a random sequence.

The word information includes meanings, illustrative sentences and practical applications of words. Further, the word information group is formed by classifying words to be memorized according to at least one of the level, frequency of use and category thereof, and setting a plurality of words into groups based on the grade of the words.

For example, level-based word groups are classified into groups A to C, in which the group A includes a plurality of primary grade English words, the group B includes a plurality of intermediate grade English words, and the group C includes a plurality of high grade English words. Further, such word groups can be classified according to the frequency of use and category.

The words in each group are randomly or sequentially displayed through the display unit 103 at the random time interval. In detail, the words in each group can be displayed according to a random sequence or a sequential sequence.

After the user has completely memorized the words in the group A, the user can select another word information group.

The memory unit 104 connected with the controller 101 includes a read only memory (ROM), which stores program and data used for processing and control of the controller 101, a random access memory (RAM), which serves as a working memory of the controller 101, and a flash memory which provides a storage area for various types of storage data.

Further, the memory unit 104 of the word information display apparatus according to the embodiment of the present invention includes a first storage unit, which stores the word information group to be memorized, and a second storage unit which stores the random time mode selected by the user.

In a case in which the present invention is applied to a mobile communication terminal, if the mobile communication terminal communicates with another mobile communication terminal through a communication protocol at the display time of word information according to the random time interval after the word display function executed the random time interval is selected, the controller 101 does not perform the word display function. Further, after the communication between the two mobile communication terminals is completed, the controller 101 displays a word corresponding to a next random time interval.

The display unit 103 can be prepared in the form of a liquid crystal display (LCD) to display various types of display data and word information generated from the word information display apparatus.

Further, the audio converter 105 includes a speaker and a vibrator to generate an audio signal or vibration when the word is displayed.

Although not shown in FIG. 1, the word information display apparatus includes a sound controller and a sound generator to provide pronunciation and alarm sound together with word information.

Preferably, at least one of the pronunciation of the word and the alarm sound is provided when the word is displayed.

The key input unit 102 can be prepared in the form of a key pad, and includes a plurality of numeral/character input keys, a function key used for an interface with a user, and a key for communication. Further, the key input unit 102 provides the controller 101 with key input values input by the user.

A receiver of the RF transceiver 106 amplifies a desired signal by maximally restricting noise amplification, and generates a digital signal through an intermediate frequency conversion process. The digital signal is analyzed and processed by the controller 101. Further, a transmitter of the RF transceiver 106 modulates a signal generated from the controller 101 into a signal of a desired frequency band and then amplifies the signal.

The random time interval may use the random time mode stored in the memory unit 104, or may be calculated by the random time interval calculator 107.

The random time interval, which can be adopted by those skilled in the art, may vary depending on selection of a manufacturer. The present invention focuses on the word information display apparatus operating at the random time interval, and the functions of the word information display apparatus can be variously embodied by those skilled in the art.

For example, the random time intervals can be calculated using two methods such as operation using a π value and operation using a time value.

According to the first method using the π value, if a user selects a function of the word information display apparatus operating at the random time interval, the random time interval calculator 107 detects the end-figure of a second of a time displayed on the mobile communication terminal. For example, when the end-figure is 4 (such as, 09:11:24 AM), the random time interval calculator 107 sets the random time interval using numerals after the decimal point of π value (3.14285714285714 . . . ). In detail, when the end-figure is 4, the random time intervals can be set by multiplying the numerals after the decimal point of π value by 5 minutes in the sequence of 4, 2, 8, 5, 7, 1, 4, 2, 8, 5, 7, 1 and 4. In such a case, the random time intervals are set to 20 minutes, 10 minutes, 40 minutes, 25 minutes, 35 minutes, 5 minutes, 20 minutes, 10 minutes, 40 minutes, 25 minutes, 35 minutes, 5 minutes and 20 minutes. Further, the multiply value can be variously set, besides 5 minutes.

The second method uses a value obtained by performing predetermined operation using an initial value.

A unique time value (for instance, lapse time by seconds from Jan. 1, 1970 to the present time) is used as the initial value. Further, a 32-bit value or a 34-bit value can be used as the initial value.

For example, when one of 1 to 50 is randomly selected and is used for the random time interval, the following equations are satisfied.

initial value=time value;

random number value=((initial value*1103515245+12345)/65536)/32768;

next alarm time=random number value/51;

Through the above equations, one random number value from 0 to 32767 can be randomly obtained. Then, the random number value is divided by 51 such that the rest of the random number value is obtained. Through repetition of the above process, random arrangement of numerals from 1 to 50 can be obtained.

Then, the numerals are multiplied by a specific time value (e.g. 5 minutes or 10 minutes), thereby obtaining the random time intervals from 5 to 250.

The two methods are for illustrative purposes only. The functions of the word information display apparatus operating at the random time interval according to the present invention can be embodied through various methods. That is, the functions can be realized using a conventional random function generator. Further, a plurality of random time modes, which can be selected in advance by a user, can be stored in the memory unit 104.

The random time intervals calculated using the above methods are stored in the memory unit 104 in the form of at least one mode.

For example, mode 1 may include 20 minutes, 10 minutes, 40 minutes, 25 minutes and 35 minutes, and mode 2 may include 5 minutes, 20 minutes, 10 minutes, 40 minutes, 25 minutes and 35 minutes.

However, the present invention is not limited to the above methods. Those skilled in the art will appreciate that the word information display apparatus operating at the random time interval can be embodied through various methods without departing from the scope of the present invention.

The word information display apparatus of the present invention as described above has a limitation of word information caused by the lack of memory capacity thereof. In this regard, when the word information display apparatus is applied to a mobile communication terminal, the word information display apparatus can receive word information through a server of a communication service provider.

According to another embodiment of the present invention, a server of a communication service provider is wirelessly connected with a mobile communication terminal, the server includes the controller 101, the memory unit 104 and the random time interval calculator 107, and the mobile communication terminal includes the display unit 103.

The controller 101 sequentially or randomly selects a word, which is stored in the memory unit 104, at a random time interval calculated by the random time interval calculator 107, and transmits the word to the mobile communication terminal through wireless communication. Then, the word information is displayed through the display unit 103 of the mobile communication terminal and an alarm function is executed.

For example, a word alarm function can be applied to a background scene content service of the mobile communication terminal.

The mobile communication terminal receives the word, which is stored in the memory unit 104, from the server at the random time interval calculated by the random time interval calculator 107.

Then, the word is locally displayed on a background scene of the mobile communication terminal or displayed in the form of a popup and pronunciation of the word or alarm sound is outputted.

Thereafter, if a new word is received from the communication service provider at the random time interval, the new word information is displayed and the alarm function is executed.

The above description is for illustrative purposes only. Those skilled in the art will appreciate that various apparatuses definitely described in the present disclosure or included in the scope of the present invention can be realized without departing from the scope of the present invention.

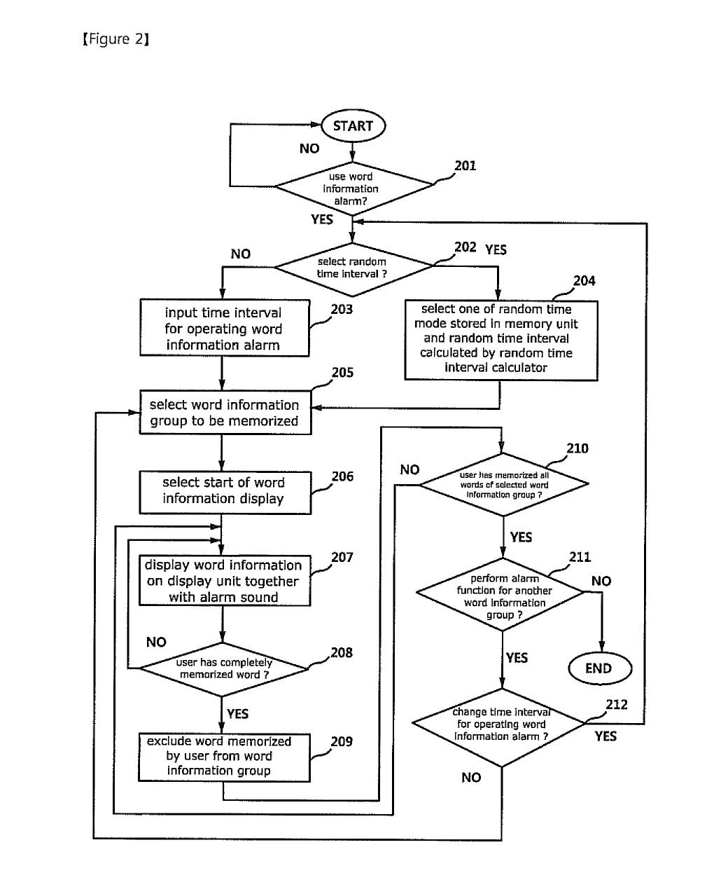

FIG. 2 is a flowchart showing the word information display method performed at the random time interval according to the present invention.

According to the method, if the word information display function executed at the random time interval is selected by a user, one of the random time mode stored in the memory unit 104 and the random time interval calculated by the random time interval calculator 107 is selected. Next, a word information group to be memorized is selected by the user and the word information is output through a mobile communication terminal in the form of a text or sound. Then, the word information memorized by the user is excluded from the word information group. Last, when all words of the word information group are memorized by the user, another word information group is selected by the user.

In more detail, as shown in FIG. 2, if the user presses a word information display key in step 201, step 202 is performed.

Next, if the user presses a periodic time interval key in step 202, a time interval for operating word information alarm is input in step 203 and then step 205 is performed. Further, if the user presses a random time interval key in step 202, one of the random time interval mode stored in the memory unit 104 and the random time interval calculated by the random time interval calculator 107 is selected in step 204 and then step 205 is performed.

Then, if the word information group to be memorized is selected in step 205, step 206 is performed. If the user presses a word information alarm key in step 206, the word information selected in step 205 is displayed at the time interval selected in step 203 or 204 together with pronunciation of the corresponding word and alarm sound in step 207. Thus, the user can memorize the word information, or can simply watch the word information or listen to the pronunciation of the word. That is, the word information is displayed through the display unit 103 of the mobile communication terminal together with the alarm sound. The word is output in the form of at least one of a text and sound. For example, the word is displayed in the form of a spelling and an illustrative sentence, or displayed through the alarm sound and pronunciation of the word.

Then, if the user has completely memorized the word displayed in step 207, the user presses a completion key in step 208. Thus, the word memorized by the user is excluded from the word information group in step 209. However, if the user has not completely memorized the displayed word, the user presses a incompletion key in step 208, so the word remains in the word information group to be memorized and steps 207 to 209 are repeated.

Then, if the user has memorized word information groups during repetition of steps 207 to 209, the user presses the completion key in step 210.

Next, if the user wants to perform an alarm function for another word information group in step 211, the user presses a “go” key for another word information group and step 212 is performed. However, if the user does not want to perform the alarm function for another word information group, the procedure ends.

In step 212, if the user wants to change an alarm time interval, the user presses a change key, so the procedure returns to step 202. However, if the user does not want to change the alarm time interval, the procedure returns to step 205, so a word information group to be memorized is selected.

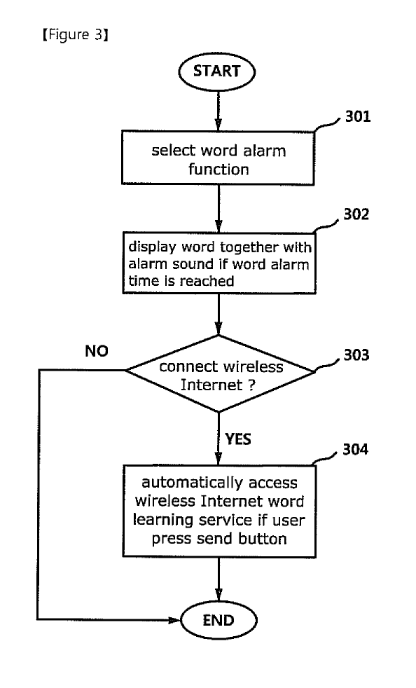

FIG. 3 is a flowchart showing a procedure of automatically accessing wireless Internet when a word alarm is performed according to the word information display method performed at the random time interval based on the present invention.

When the word information display apparatus of the present invention is applied to the mobile communication terminal, the memory unit 104 of the word information display apparatus stores word information having a wireless Internet access identification number for a word learning service provided through a communication service provider.

Further, if a user presses a send button when alarm of a word having the wireless Internet access identification number operates, the controller 101 allows the mobile communication terminal to automatically receive a wireless Internet service through the wireless Internet access identification number corresponding to the displayed word information.

If the word alarm function is performed in the mobile communication terminal, ring tone or vibration is generated when the word is displayed. For example, the word has a wireless Internet access identification number such as *88.

If the user presses the send button in order to learn detailed information related to the word through the wireless Internet, the mobile communication terminal automatically dials the wireless Internet access identification number *88 to access a wireless Internet scene.

When the user changes the communication service provider, word information, which has a wireless Internet access identification number for a word learning service provided through another communication service provider, can be newly stored in a memory unit through an RF transceiver or a dedicated cable. In detail, since communication service providers may have wireless Internet access identification numbers different from each other, when a communication service provider is changed, word information, which has a wireless Internet access identification number provided from the changed communication service provider, is newly stored in a memory unit.

Preferably, the word information further includes a learning information access identification number through which the mobile communication terminal directly accesses a wireless Internet scene which displays the word information in the word learning service.

For example, an English word “patent” has the learning information access identification number *8812 as well as the wireless Internet access identification number *88.

When the alarm function is performed for the word “patent”, since the wireless Internet access identification number *88 is assigned, if the user presses the send button, the mobile communication terminal automatically dials the wireless Internet access identification number *88 to access a main scene of the word learning service provided through the wireless Internet. Consequently, the mobile communication terminal can receive the word learning service and the user can watch the word information on a scene displaying the word information, or search for other English words instead of the displayed word.

Further, the learning information access identification number *8812 is also assigned to the word “patent”. Thus, if the user presses the send button by selecting the learning information access identification number *8812, the mobile communication terminal can directly access a scene displaying information of the word “patent”. That is, if the learning information access identification number is used, the mobile communication terminal can directly access the scene displaying the meaning, practical application and an illustrative sentence of the word “patent”.

In brief, when the alarm function is performed for a word, since the wireless Internet access identification number is automatically assigned to the word, if the user presses the send button, the mobile communication terminal automatically accesses the main scene of the word learning service provided through the wireless Internet. Further, if the user presses the send button by selecting the learning information access identification number, the mobile communication terminal directly accesses the scene displaying information of the word.

In contrast, when the alarm function is performed for a word, since the learning information access identification number is automatically assigned to the word, if the user presses the send button, the mobile communication terminal directly accesses the scene displaying information of the word. Further, if the user presses the send button by selecting the wireless Internet access identification number; the mobile communication terminal accesses the main scene of the word learning service provided through the wireless Internet.

That is, since at least one of the wireless Internet access identification number and the learning information access identification number is assigned to a word, the mobile communication terminal can access the main scene of the word learning service provided through the wireless Internet or directly access the scene displaying information of the word.

FIG. 3 shows a procedure in which the mobile communication terminal automatically accesses the wireless Internet when the word alarm function is performed according to the word information display method using the word information display apparatus.

As shown in FIG. 3, according to the word information display method of the present invention, the word alarm function of the word information display apparatus is selected to start word information display (301), word information having the wireless Internet access identification number is displayed together with alarm sound if word alarm time is reached (302), additional learning through the wireless Internet is determined by a user if the word alarm function is performed (303), and the mobile communication terminal automatically accesses the wireless Internet English word service provided through a communication service provider if the user presses the send button (304).

In 301, the user selects a word group from level-based word groups stored in the word information display apparatus, and sets an operation time interval for operating the word alarm.

The user can select ring tone, vibration or an LED as an alarm signal. Then, the user sets the level of a word, alarm interval (word information display interval) and the type of alarm signals and presses an “enter” button, so the word alarm function starts.

In 302, if the word alarm time is reached, the word alarm is performed according to the type of the alarm signals set by the user in 301 together with the display of the word to be memorized. The user can improve vocabulary ability by repeatedly watching the word or listening to pronunciation of the word through the word alarm performed at the random time interval.

In 303, the user determines the additional learning through the wireless Internet.

Since the word alarm function may not be provided from a server of a communication service provider through a communication network, word information provided to the user is limited due to the lack of memory capacity of the word information display apparatus. Thus, when the user wants to learn more information about the word displayed through the word alarm, the user can use the learning service using the wireless Internet.

In 304, if the user presses the send button, the mobile communication terminal automatically accesses the wireless Internet English word service provided through the communication service provider.

That is, when the user wants the additional learning through the wireless Internet in a state in which the word having the wireless Internet access identification number is displayed on the mobile communication terminal, if the user presses the send button in step 303, the mobile communication terminal automatically accesses the wireless Internet word learning service in step 304.

However, when the user does not want the additional learning through the wireless Internet, if the user presses a cancel button, the word alarm is completed.

In the word information stored in the memory unit for the word alarm function of the word information display apparatus, words may have wireless Internet access identification numbers different from each other. Thus, if the user presses the send button while watching a word having a wireless Internet access identification number, the mobile communication terminal can access an additional word learning service related to the word through the wireless Internet.

The word information display apparatus includes a mobile communication terminal, a navigation system, an MP3 player, a portable game player, a portable watch, a car audio system, a portable multimedia player (PMP), a playstation portable (PSP), an electronic dictionary, a digital camera, a toy, a computer for an infant, a portable notebook, and a learning device. In addition, the word information display apparatus may include all devices capable of improving vocabulary ability of a user.

While certain embodiments have been described above, it will be understood that the embodiments described are by way of example only. Accordingly, the systems and methods described herein should not be limited based on the described embodiments. Rather, the systems and methods described herein should only be limited in light of the claims that follow when taken in conjunction with the above description and accompanying drawings.

### INDUSTRIAL APPLICABILITY

The invention can be applied to a mobile communication terminal, a navigation system, an MP3 player, a portable game player, a portable watch, a car audio system, a portable multimedia player (PMP), a playstation portable (PSP), an electronic dictionary, a digital camera, a toy, a computer for an infant, a portable notebook, and a learning device.

1. A word information display apparatus operating at a random time interval, the word information display apparatus comprising:
a random time interval calculator configured to calculate the random time interval;
a memory unit configured to store word information, which is to be memorized, classified into a plurality of word groups;
a controller configured to sequentially or randomly select a word stored in the word groups at the time interval calculated by the random time interval calculator; and
a display unit configured to display the selected word under control of the controller.

2. The word information display apparatus as claimed in claim 1, wherein the word group includes the word information classified according to at least one of a level, frequency of use and a category, and a plurality of words are set in each group based on grades of the words.

3. The word information display apparatus as claimed in claim 1, wherein the random time interval is calculated by performing operation using one of a π value and a time value.

4. The word information display apparatus as claimed in claim 1, further comprising a sound controller and a sound generator configured to provide pronunciation of the word or alarm sound when the word information is displayed.

5. The word information display apparatus as claimed in claim 1, wherein the memory unit includes a receiver configured to receive the word information through wireless communication and an electric wave.

6. The word information display apparatus as claimed in claim 1, wherein the memory unit stores word information having a wireless Internet access identification number related to a word learning service provided through a communication service provider, and the controller allows the word information display apparatus to automatically access a word learning service through a wireless Internet access identification number corresponding to the displayed word if a user presses a send button when an alarm function is performed for the word having the wireless Internet access identification number.

7. The word information display apparatus as claimed in claim 6, wherein, when the user changes the communication service provider, word information, which has a wireless Internet access identification number related to a word learning service provided through the changed communication service provider, is newly stored in the memory unit through an radio frequency transceiver or a dedicated cable.

8. The word information display apparatus as claimed in claim 6, wherein the word information further comprises a learning information access identification number for directly accessing a scene displaying the word information in the word learning service.

9. A word information display apparatus operating at a random time interval, the word information display apparatus comprising:
a memory unit configured to store word information, which is to be memorized, classified into a plurality of word groups, and at least one random time mode;
a controller configured to sequentially or randomly select a word stored in the word group according to the random time mode stored in the memory unit; and
a display unit configured to display the selected word under control of the controller.

10. The word information display apparatus as claimed in claim 9, wherein the word group includes the word information classified according to at least one of a level, frequency of use and a category, and a plurality of words are set in each group based on grades of the words.

11. The word information display apparatus as claimed in claim 9, wherein the random time interval is calculated by performing operation using one of a π value and a time value, and the random time interval calculated through the operation is stored with at least one mode.

12. The word information display apparatus as claimed in claim 9, further comprising a sound controller and a sound generator configured to provide pronunciation of the word or alarm sound when the word information is displayed.

13. The word information display apparatus as claimed in claim 9, wherein the memory unit includes a receiver configured to receive the word information through wireless communication and an electric wave.

14. The word information display apparatus as claimed in claim 9, wherein the memory unit stores word information having a wireless Internet access identification number related to a word learning service provided through a communication service provider, and the controller allows the word information display apparatus to automatically access a word learning service through a wireless Internet access identification number corresponding to the displayed word if a user presses a send button when an alarm function is performed for the word having the wireless Internet access identification number.

15. The word information display apparatus as claimed in claim 14, wherein, when the user changes the communication service provider, word information, which has a wireless Internet access identification number related to a word learning service provided through the changed communication service provider, is newly stored in the memory unit through an radio frequency transceiver or a dedicated cable.

16. The word information display apparatus as claimed in claim 14, wherein the word information further comprises a learning information access identification number used for directly accessing a scene displaying the word information in the word learning service.

17. A word information display apparatus wirelessly connected with a server of a communication service provider, wherein the server comprising:
a random time interval calculator configured to calculate a random time interval;
a memory unit configured to store word information, which is to be memorized, classified into a plurality of word groups; and
a controller configured to sequentially or randomly select a word stored in the word groups at the time interval calculated by the random time interval calculator;
and wherein the selected word is transmitted to a mobile communication terminal through wireless communication.

18. A word information display method performed at a random time interval, the word information display method comprising:
selecting one of a random time mode stored in a memory and a random time interval calculated by a random time interval calculator if a word information display function performed at the random time interval is selected by a user;
selecting by the user a word information group to be memorized;
displaying word information of the selected word information group through a mobile communication terminal in a form of a text or sound; and
selecting by the user another word information group when the user has completely memorized the selected word information group.

19. A word information display method performed at a random time interval, the word information display method comprising:
selecting a word alarm function of a word information display apparatus to start word information display;
displaying word information having a wireless Internet access identification number together with alarm sound when a word alarm time is reached;
determining by a user additional learning through wireless Internet if the word alarm function is performed; and
automatically accessing a wireless Internet English word service provided through a communication service provider if the user presses a send button to access the wireless Internet.
